(19) United States
(12) Patent Application Publication
(10) Pub. No.: US 2011/0261065 A1
(43) Pub. Date: Oct. 27, 2011

(54) Method for the production of images in real time

(75) Inventor: Dongmei PEI XING, Saint Maur Des Fosses (FR)

(73) Assignee: THALES, Neuilly-sur-Seine (FR)

(21) Appl. No.: 13/028,933

(22) Filed: Feb. 16, 2011

(30) Foreign Application Priority Data
Feb. 16, 2010 (FR) 10 00648

(51) Int. Cl. G09G 5/02

(52) U.S. Cl. 345/589

(57) ABSTRACT

A method for the production of two-dimensional images in real time is notably used by a simulation application using a graphics board to generate the said images in real time. Objects generated by the simulation application, composing a scene to be displayed, comprise standard objects and objects of interest for the simulation. The standard objects are processed directly by the graphics board. The objects of interest are processed more sharply by using computation means of the graphics board that are managed by the application.

The present invention relates to a method for the production of two-dimensional images in real time. The invention applies notably to visual systems used in flight or driving simulators.

Flight or driving simulators may have the purpose of training personnel in driving machines such as lorries, aircraft, helicopters. The driving of certain machines such as aircraft requires very serious training. Specifically, the equipment entrusted to the pilot is sometimes extremely costly. Moreover, the machine may also be a means for transporting people; in this case the person controlling the machine is responsible for human lives. It is therefore necessary to obtain a very high skill level for the personnel driving such machines.

In the simulators, the visual reproduction of the environment of the pilot or pilots is an important factor for obtaining a high-quality simulation.

The market for visual reproduction systems suitable for simulators is greatly expanding. In this context, the manufacturers of visual reproduction systems suitable for simulators are increasingly using off-the-shelf equipment for processing the images in order to reduce production costs. Specifically, certain off-the-shelf products, such as graphics boards, can make it possible to obtain an image quality close to a product fully developed by a simulator manufacturer. On certain graphics boards, the level of quality of the final image can be adjusted depending, for example, on whether it is desired to have better performance in computation time or whether it is desired to give preference to the quality of the image.

However, the images produced by off-the-shelf graphics boards have considerable geometric aliasing. Geometric aliasing is a staircasing effect on the display of the edges of the objects of an image. The problem of geometric aliasing is very clear on thin or small objects. Yet thin or small objects may be very important for a simulation: for example considerable aliasing on markings of a landing runway may be a very disrupting factor for an aircraft pilot under training. Moreover, in images comprising considerable movement, the fixed and thin objects may disappear. Such a disappearance of objects is a great disadvantage for the quality of a simulation.

There are several technical solutions for limiting geometric aliasing in an image.

A first anti-aliasing method is called FSAA, the acronym for Full Scene Anti-Aliasing. The FSAA method uses a two-dimensional image with a resolution n times greater than the final resolution, n being an integer strictly greater than one. Take for example n as being four. The FSAA method therefore uses an initial image with a resolution on (x,y) that is four times greater than the resolution of the final image. Therefore, for each pixel of the final image, there are four pixels of the initial high-resolution image. The four pixels of the initial image are called the samples. Then a low-pass filter is applied to this initial image for example to eliminate the high frequencies of the image. Filtering a high-resolution image in order to obtain an image of lower resolution amounts to carrying out “down-sampling”. This method is limited by the hardware capabilities of the graphics board used. Specifically, in order to obtain a good quality image exhibiting little aliasing, it is necessary to take an initial image having a considerable resolution. The computations on this image are then costly in time and do not allow displaying images in real time. Moreover the maximum resolution of an image is limited so it is not possible to use an initial image at a higher resolution in order to have a better quality of image.

A second method that can be used is an MSAA method, the acronym for Multi-Sampling Anti-Aliasing. The MSAA method is an optimization of the FSAA method. The geometry of the objects of the initial image is constructed with the aid of polygons. Instead of having n samples for all the pixels of the final image, the MSAA method is applied only to the edges of these polygons. Moreover, the multi-sampling is applied only to the geometry; only one sample of colour per pixel is generated.

Therefore, a coverage mask is composed from the n samples of the geometry for each available pixel for the display and the final colour of the pixel is the multiplication of the colour sample by the coverage mask.

The MSAA method can be coupled with a CSAA method, the acronym for Coverage Sampling Anti-aliasing. The CSAA method consists in using a buffer, for the coverage of the pixels, that differs from the buffer comprising the colours of the initial image, as used by the MSAA. This method, by decoupling the buffer comprising the coverage data to which the anti-aliasing process is applied, makes it possible to reduce the bandwidth used by the anti-aliasing process.

In this second method, and in its combination with a CSAA method, only a limited number of samples per pixel can be used. Moreover, the use of an MSAA with a high number n of samples is very costly in computing time. It is therefore impossible by these methods to obtain the precision desired for the image to be displayed at the same time as real-time operation.

One purpose of the invention is notably to produce two-dimensional images, in real time. The method according to the invention is notably used by a simulation application using a graphics board to generate the said images in real time. Objects generated by the simulation application, composing a scene to be displayed, comprise standard objects and objects of interest for the simulation. The standard objects are processed directly by the graphics board. The objects of interest are processed more sharply by using computation means of the graphics board that are managed by the application.

Accordingly, the subject of the invention is a method for the production of images in real time by a simulation application using a graphics board for generating the said images in real time. The said images comprise notably standard objects and objects of interest for the simulation. The method according to the invention comprises at least the following steps for each image:
computation by the graphics board of the colours of the pixels of the image in order to represent the standard objects, storage of the colours of the pixels in order to represent the standard objects, in a buffer memory of the graphics board;
for each object of interest:
   computation of at least two projection matrices of the object of interest in an image plane by the application, the said matrices being offset spatially relative to one another;
   for each previously-computed matrix, computation by the graphics board of second coverage masks of the pixels of the image plane;
   cumulation by the application of the second coverage masks of the pixels of the image by the object of interest in the buffer memory of the graphics board;
   computation by the graphics board of colours of the image plane for the pixels representing the object of interest;
   cumulation by the application of the colours of the object of interest in the buffer memory of the graphics board;
display of the buffer memory by the graphics board.

A weighting can advantageously be applied to each coverage mask computed for a projection matrix during the cumulation by the application of the second coverage masks.

In another advantageous embodiment, the projection matrices may be spatially offset between each image.

Each projection matrix can for example be centred on a sampling of a target object to be displayed by a pixel.

The main advantages of the invention are notably to improve the quality of the images produced while having a real-time display of these images.

Other features and advantages of the invention will appear with the aid of the following description, given as an illustration and not being limiting, and made with respect to the appended drawings which represent:

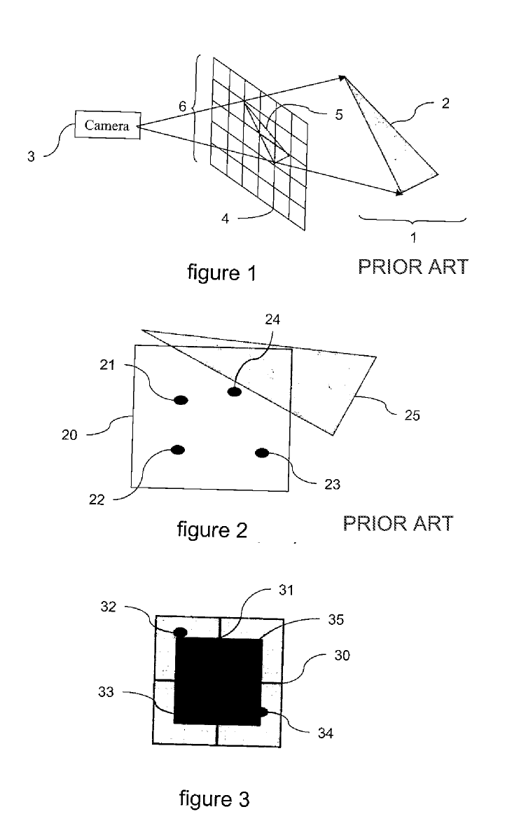

FIG. 1: essential elements for a generation of images according to the prior art;

FIG. 2: an example of a coverage mask computed from four samples according to the prior art;

FIG. 3: an example of oversampling according to the invention;

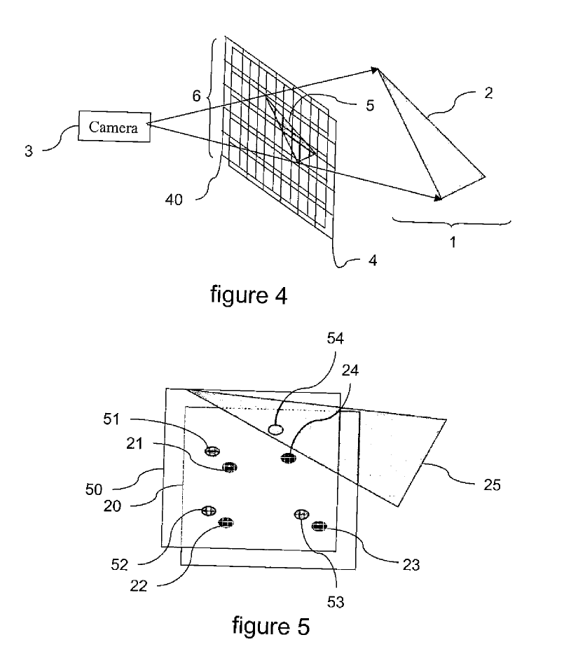

FIG. 4: an example of image plane movement for a computation of a coverage mask according to the invention;

FIG. 5: a coverage mask computed by the method according to the invention;

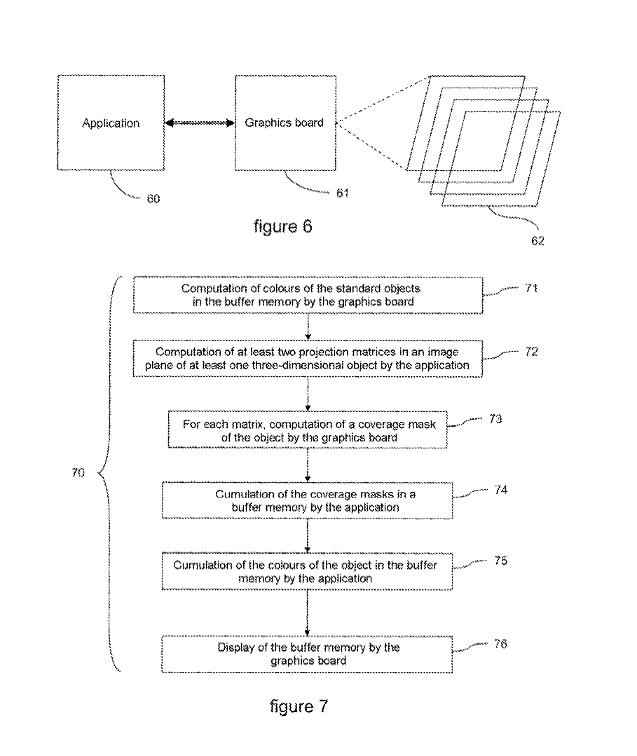

FIG. 6: a schematic representation of the operation of an application producing images;

FIG. 7: a flowchart of the main steps of the method according to the invention;

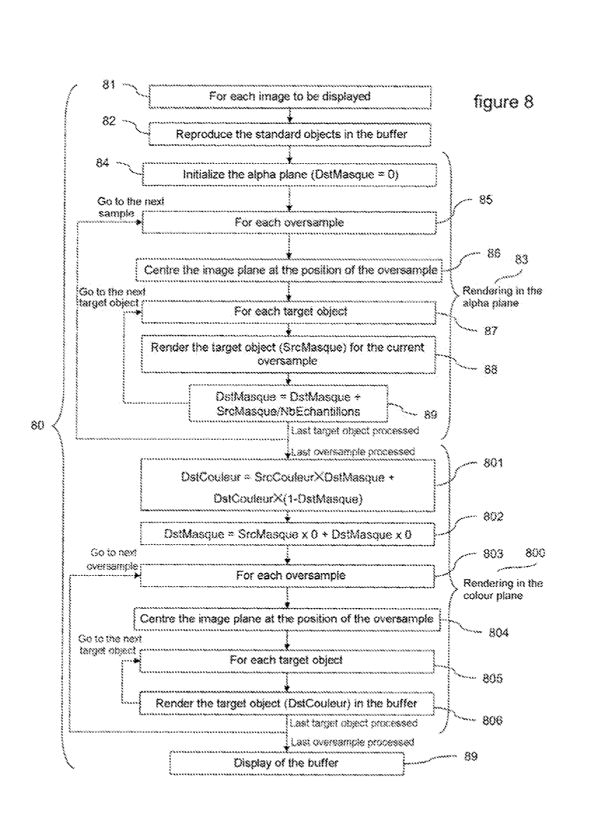

FIG. 8: a first example of computing the image rendering using the method according to the invention;

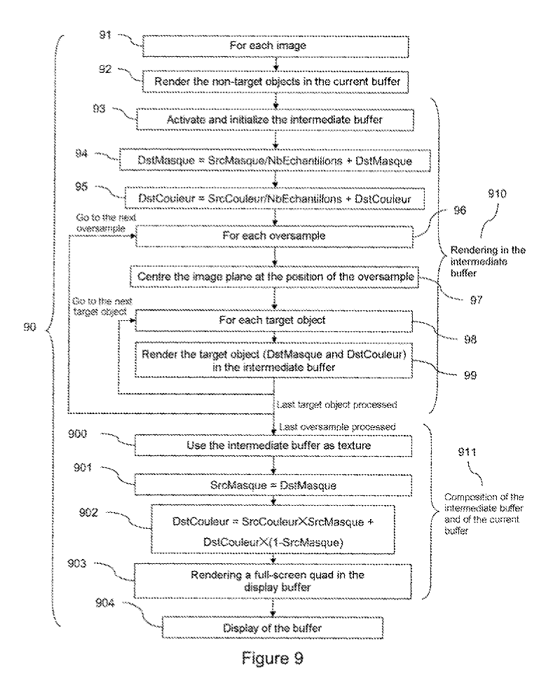

FIG. 9: a second example of computing the image rendering using the method according to the invention.

FIG. 1 represents schematically a generation of an image by a graphics board. The generated image represents a scene 1. A scene 1 may be composed of one or more three-dimensional objects 2. The three-dimensional objects 2 can be modelled in the form of polygons. A camera 3 can project onto a screen generated images of the scene 1. For this purpose, an image-generation method constructs an image plane 4 comprising an image 5 of the scene 1. It is the image plane 4 which, once constructed, is projected onto a display screen. The image plane 4 consists of a set of pixels 6. Each pixel is associated with an RGB (for Red Green Blue) colour. Each pixel is also associated with an opacity component called alpha. An alpha plane is a set of alpha components for each pixel of the image plane. A value of the opacity component, also called the alpha value, can represent coverage of a pixel by a projection 5 of the polygon 2 onto the image plane 4. The projection 5 of the polygon 2 onto the image plane 4 is an image 5 of the polygon 2. The set of polygons composing the scene 1 is therefore projected onto the image plane 4. The projection of each polygon onto the image plane 4 colours each pixel of the image plane 4 depending on the coverage of each pixel by one or more projected polygons.

A well-known method of converting a polygon projected onto an image plane into coverage of pixels is called rasterization. In general, rasterization is a method converting a vectorial image into a matrix image intended to be displayed on a screen. The quality of the rendering of an image by a rasterization method depends on the number of samples of the image 5 used to calculate the colour and the coverage of a pixel by the image 5. For example, it is necessary to use several samples per pixel in order to prevent staircasing effects in the final rendering of the image projected onto the screen. The staircasing effects are commonly called aliasing effects. In general, a rendering of an image is a representation of a three-dimensional model of the scene by a display and a processing of the surfaces of the model based on parameters of texture, colour, light and shade.

FIG. 2 represents an example of a first coverage mask 20 of a pixel computed on the basis of four samples 21, 22, 23, 24 of a polygonal geometry 25. The first coverage mask 20 represents the alpha value of the pixel. The four samples represented for the example in FIG. 2 do not have intersection with the geometry 25, the alpha value of coverage of the pixel by the geometry is therefore zero.

The first coverage mask 20 can be obtained by an MSAA sampling method, the acronym for Multi-Sampling Anti-Aliasing. An MSAA sampling method is usually provided by graphics boards according to the prior art. It is possible to choose the number of samples desired for rasterization by the MSAA method depending on the quality and performance requirements. However, the number of samples that can be used by an MSAA method can be limited by the hardware performance of the graphics board. Moreover, using more than eight samples considerably slows the performance of image generation.

One solution for obtaining a higher number of samples than that allowed by the graphics board can be to artificially increase the image resolution. An image, for example four times larger than the image 5 of the image plane 4, can be generated in an intermediate image plane. The intermediate image plane is a temporary image plane. However, there is also a hardware limitation to the size of the image generated in the intermediate image plane. Moreover, in order to generate an image of higher resolution, it is necessary to use a great deal of graphic memory. Graphic memory is however costly. This solution also leads to deterioration in image-generation performance.

FIG. 3 represents an example of an oversampling zone 30 according to the invention. One of the principles of the method according to the invention is to use usual methods proposed by the graphics board to represent objects of the scene, objects that are not very discriminating for training, and to apply a particular process for certain objects of the scene. For example, in an aircraft pilot training simulation, certain objects such as the runway beacons, the edges of runways, must be represented as sharply as possible. Specifically, the attention of the pilot during a landing is concentrated on the objects indicating or delimiting the landing runway. Other objects forming part of the surroundings such as distant buildings, a control tower, do not require very precise display during landing. The display processing according to the invention carries out a geometric oversampling of the discriminating objects. The proposed oversampling uses one movement of the image plane for each oversample. First of all, this involves positioning the oversamples. An oversampling zone is defined in pixel units, then, the oversamples are distributed for example in a uniform manner over the oversampling zone. For example, FIG. 3 represents an oversampling zone 30 representing 1.5 pixel. The oversampling zone 30 is centred on a pixel 31. In the oversampling zone 30, for example four first oversamples 32, 33, 34, 35 can be taken. For example, the oversampling zone 30 can be divided into four equal parts. One oversampling position can then be drawn at random from each part of the oversampling zone 30.

FIG. 4 represents an example of a movement of the image plane 4 for a computation of a coverage mask according to the invention. In order to generate oversamples of target objects, the method according to the invention uses a movement of the image plane 4, as shown in FIG. 1. The image plane 4 can be moved in a vectorial translation for example. A movement of the image plane 4 can for example be made so that the centre of each pixel 6 corresponds to a position of an oversample 32, 33, 34, 35 as shown in FIG. 3. The movement of the image plane 4 gives an offset image plane 40 shown in FIG. 4.

FIG. 5 represents an example of a second coverage mask 50 computed based on four second oversamples 51, 52, 53, 54, 55 taken from the offset image plane 40, shown in FIG. 4. The four second oversamples 51, 52, 53, 54 can be taken from the offset image plane 40 in the same manner as the four first samples 21, 22, 23, 24 of the image plane 4. The mask computed by using the four second oversamples 51, 52, 53, 54 is more precise. Specifically, one of the second oversamples 54 is positioned on the polygonal geometry 25. The polygonal geometry 25 comprises an intersection with the second coverage mask 50. The coverage value of the pixels computed with the second coverage mask 50 is therefore not zero. Advantageously, the coverage value computed based on the first coverage mask 20 and on the second mask 50 makes it possible to bring greater accuracy to the computation of the coverage masks.

FIG. 6 represents schematically an operation of an application 60 producing images. The application 60 can, for example, apply the method according to the invention in order to produce a time sequence of images 62. The application 60 can be a simulation application generating images intended to reproduce a visual environment for a simulation. For example, the application 60 can generate images intended to be projected onto a screen simulating an environment for a pilot of an aircraft. For this purpose, the application manages three-dimensional virtual objects modelling an environment in which the aircraft can move. The application 60 uses the graphics board 61 to compute coverage masks of various objects of the scene to be displayed on a screen. Notably, the polygons of the objects are converted into a coverage mask by a standard rasterization method used by the graphics board 61. The coverages computed are stored in the alpha components of the image plane, to be displayed by the rasterization method. The application 60 uses first “blending” functions supplied by the graphics board 61 in order to cumulate the various coverage masks computed by the application 60, notably: the coverage masks computed for the image plane 4, the coverage masks computed for the moved image plane 40, represented in FIG. 4. The application 60 also used second “blending” functions for combining a rendering of target objects with the rest of the scene. The target objects are for example objects of operational interest that have been the subject of an oversampling according to the invention. The target objects may also be objects sensitive to aliasing, such as thin objects. The rest of the scene can be rendered directly by the graphics board 61 without specific processing on the part of the application 60. The graphics board 61 can use a rasterization method of the MSAA type. The image plane to be displayed is itself stored in a buffer memory, routinely called a “frame buffer”. As soon as an image is completely computed, the application 60 asks the graphics board 61 to display the computed image. The graphics board 61 then displays the data contained in the frame buffer. The various interchanges between the application 60 and the graphics board 61 are detailed below.

FIG. 7 represents general steps of the method 70 for producing images according to the invention. The method according to the invention produces images representing a scene 1 that can change in real time. The scene, at a given moment, may comprise a set of objects to be reproduced. Amongst the objects to be reproduced, a subset of particular objects is defined. For example, the subset of particular objects may comprise objects being of crucial importance for the simulation, objects difficult to render without deterioration of their image. The particular objects may for example be defined in a database. The particular objects are then called target objects. The objects that are not included in the target objects of the scene 1 are hereinafter called standard objects.

A first step 71 of the method according to the invention 70 may be a step of colour rendering for the standard objects. The rendering for the standard objects may be carried out by rasterization and standard rendering methods of the graphics board 61.

A second step 72 of the method according to the invention 70 may be a step of computation of projection matrices of target objects onto a first image plane 4 by the application 60. A projection matrix makes it possible to project objects, for example from the camera 3, onto the image plane 4. A projection matrix comprises a meshwork, in which each mesh represents a pixel of the image plane 4. Several projection matrices can be defined. For example, four projection matrices can be computed, each comprising a different meshwork. The meshworks of the various projection matrices can be offset relative to one another by a fraction of a pixel in a defined direction for example. An offset between two meshworks of pixels is shown in FIG. 4 between the image plane 4 and the offset image plane 40.

A third step 73 of the method according to the invention 70 can be a step of computing a coverage mask for each projection matrix and for each target object of the scene. The computation of the coverage mask for each matrix is carried out by the graphics board 61 at the request of the application 60.

Once the coverage masks are computed for each projection matrix, a fourth step 74 can be a step of cumulating the coverage masks of the target objects in a display buffer, or display buffer memory, managed by the graphics board 61. The cumulation of the computed coverage masks is carried out by the graphics board 61 at the request of the application 60.

A fifth step 75 can be a step of cumulating the colours of the target and standard objects in the display buffer managed by the graphics board 61 with the aid of the cumulation of the masks computed during the fourth step 74. The cumulation of the colours can be carried out by the graphics board 61 at the request of the application 60.

When the display buffer contains all the objects of the scene, it is transmitted for example to a projector, by the graphics board 61, for the display of the image 62: this is the sixth step 76 of the method according to the invention.

FIG. 8 represents a first exemplary embodiment 80 of the image-production method 70 according to the invention.

The first exemplary embodiment of the image-production method 70 according to the invention carries out a process for each image of the scene 1 to be displayed 81.

An object of a seventh step 82 of the first example 80 can be to reproduce each standard object 82 of the scene 1 in the display buffer of an image. This seventh step 82 corresponds to the first step 71 of the method 70 according to the invention, shown in FIG. 7. In order to reproduce the standard objects in the display buffer, the application 60 uses normal image-processing methods of the graphics board 61 of the MSAA type for example. Advantageously, the normal image-processing methods of the graphics boards make it possible to display objects that are of a sufficient rendering quality for standard objects. The display buffer may comprise an image plane. The image plane may itself comprise an alpha plane and a colour plane, the alpha plane containing the coverages of each pixel, the colour plane containing the colours of each pixel.

A first set of steps 83 makes it possible to compute a rendering of the target objects in the alpha plane. A second set of steps 800 makes it possible to compute a rendering of the target objects in the colour plane, RGB for example. Once the alpha plane and the colour plane are composed with the target objects and the standard objects, the two planes are cumulated in the display buffer. The display buffer can then be projected onto a screen. The graphics board 61 can, for example, transmit the display buffer comprising the image to be displayed to a display device.

An eighth step 82 of the first example 80 is a step of initialization of the alpha component of the image plane. The alpha component, or the alpha plane, is marked DstMasque in FIG. 8. The initialization of the alpha plane amounts to setting DstMasque to zero: DstMasque=0.

Then, for each oversample 85 of each projection matrix, the steps described below are carried out: a ninth step 86, a tenth step 88, an eleventh step 89. The projection matrices have been computed in advance.

A ninth step 86 is a step during which the image plane is centred on the position of the current oversample. This step amounts to offsetting the current projection matrix.

Then, for each current target object 87, the following steps are carried out: the tenth step 88, the eleventh step 89.

The tenth step 88 is a step of rendering of the current target object by the graphics board 61. The rendering of the current target object is the mask of the current target object called SrcMasque in FIG. 8.

The eleventh step 89 is a step of cumulating the computed masks for each target object in the alpha plane. The cumulation of the masks is carried out by a weighted total of the said masks for each oversample. A weighting is applied to each oversample. In the example shown in FIG. 8, each oversample can have the same weighting: 1/NbEchantillons, NbEchantillons representing the number of oversamples. Other weightings can be applied such as for example a Poisson's law.

Then the method moves to another target object and repeats the tenth step 88. When all the target objects have been processed, the method moves to a next oversample; the next oversample becomes the current oversample. And for each target object 87, the method carries out the tenth and eleventh steps 88, 89. When all the oversamples have been processed, the method carries out a twelfth step 801 forming part of the rendering in the colour plane 800.

The twelfth step 801 is a step for positioning a cumulation function for the rendering of the colours of the target objects by the graphics board 61. The colours of the standard objects have previously been rendered in a buffer corresponding to the colour plane: DstCouleur. The DstCouleur buffer is then modified by the following computation: DstCouleur=SrcCouleur×DstMasque+DstCouleur×(1−DstMasque). SrcCouleur being the colour of the target objects computed in the step 806 and DstMasque comprising the cumulation of the weighted masks.

A thirteenth step 802 is a step for positioning a cumulation function for the alpha plane. DstMasque is reset to zero when a first sample is rendered in the pixel in the following manner: DstMasque=SrcMasque×0+DstMasque×0. The cumulation function thus defined prevents an overwriting of the samples of the target objects in one and the same pixel.

The functions of cumulating the rendering of the colours and of cumulating in the alpha plane, positioned respectively during the twelfth step 801 and the thirteenth step 802 are then applied when the target objects are rendered during a fifteenth step 806 described below.

For each oversample 803, the steps described below are carried out: a fourteenth step 804, a fifteenth step 806 for a current oversample, then following the fifteenth step 806, the process returns to the fourteenth step 804 for a next oversample, if there is one, which then becomes the new current oversample.

The fourteenth step 804 is a step during which the image plane is centred on the position of the current oversample. This step amounts to offsetting the current projection matrix.

Then, for each current target object 805, the fifteenth step 806 is carried out.

The fifteenth step 806 makes it possible to render the colours of the target object in the display buffer. The colours and the alpha plane of the current target object are supplied by the graphics board and retrieved from DstCouleur and DstMasque by the application of the functions of cumulating the rendering of the colours and of cumulating the alpha plane, defined respectively during the twelfth step 801 and the thirteenth step 802. If there is a next target object, it replaces the current target object and the process returns to the fifteenth step 806 until all the target objects have been processed. When all the target objects have been processed, the process moves to an oversample following the current oversample if there is one and repeats the fourteenth step 804.

When all the oversamples have been processed, the display buffer is transmitted 89 to a display means.

FIG. 9 represents a second exemplary embodiment 90 of the image-production method 70 according to the invention. The second example 90 advantageously uses an additional memory in order to make the computations. Advantageously, the use of such an additional memory makes it possible to simplify the computations.

For each image produced 91, of a scene to be displayed, a sixteenth step 92 is a step for rendering standard objects in a display buffer. The rendering of the standard objects is carried out, as during the seventh step 82, by the graphics board.

A first portion 910 of the second example 90 allows a rendering of the current image in an intermediate buffer. The first portion 910 of the second example may comprise: a seventeenth step 93, an eighteenth step 94, a nineteenth step 95, a twentieth step 97, a twenty-first step 99.

A second portion 911 of the second example 90 can be a step of composing the intermediate buffer with a current buffer. The second portion 911 of the second example 90 may comprise the following steps: a twenty-second step 900, a twenty-third step 901, a twenty-fourth step 902, a twenty-fifth step 903.

A twenty-seventh step 904 corresponds to a step of displaying the display buffer by transferring the display buffer to a display means.

The seventeenth step 93 is a step for activating and initializing the intermediate buffer.

The eighteenth step 94 is a step for defining a function of cumulating coverage masks in the intermediate buffer: DstMasque=SrcMasque×1/NbEchantillons+DstMasque, NbEchantillons being the number of oversamples in question.

The nineteenth step 95 is a step of defining a function of cumulating colour in the intermediate buffer:

DstCouleur=SrcCouleur×1/NbEchantillons+DstCouleur×(1−DstMasque)

Then, for each oversample 96 of each projection matrix, the following steps may be carried out: the twentieth step 97, the twenty-first step 99.

The twentieth step 97 is a step during which the image plane is centred on the position of the current oversample. This step amounts to offsetting the current projection matrix.

Then, for each current target object 98, the twenty-first step 99 is carried out. Once the current target object has been processed during the twenty-first step 99, a next target object becomes the current target object.

The twenty-first step 99 is a step during which the target object is rendered in the intermediate buffer. That is to say that DstMasque and DstCouleur are placed in memory for the current target object in the intermediate buffer, the said DstMasque and DstCouleur first having been cumulated according to the cumulation functions defined during the eighteenth and nineteenth steps 94, 95, with the corresponding values for DstMasque and DstCouleur, stored in the intermediate buffer.

Once the last oversample has been processed, the intermediate buffer is used as a texture during a twenty-second step 900. The texture is stored in the display buffer.

The twenty-third step 901 is a step for initializing SrcMasque with DstMasque.

The subsequent twenty-fourth step 902 is a step for computing DstCouleur based on the following function: DstCouleur=SrcCouleur×SrcMasque+DstCouleur×(1−SrcMasque). DstCouleur is then stored in the display buffer.

The twenty-fifth step 903 is a step of rendering a full-screen quad, that is to say a rectangle of the size of the image to be displayed in the display buffer.

A twenty-sixth step 904 is a step of transmitting the display buffer to a display means in order to project the image contained in the display buffer onto a screen, for example.

The method according to the invention makes it possible to obtain a very high quality of anti-aliasing on objects of the simulation that are operationally important. Advantageously, the use of an MSAA method on the objects of lesser operational importance makes it possible to obtain a sufficient quality of representation for these objects, while not degrading the display performance.

The method according to the invention makes it possible to obtain display performances compatible with a presentation of images changing in real time.

Advantageously, the method according to the invention is applied by a simulation application using a graphics board to generate images in real time. Objects generated by the simulation application, composing a scene to be displayed, comprise standard objects and objects of interest for the simulation. The standard objects are processed directly by the graphics board in order to maintain good performance in the real-time display. The objects of interest are processed more sharply by using computation means of the graphics board, managed by the application. Thus, the method according to the invention offers a compromise making it possible simultaneously to obtain images of good operational quality while maintaining image production in real time, thus safeguarding the quality of the simulation.

1. for the production of images in real time by a simulation application using a graphics board for generating the said images in real time, the said images comprising standard objects and objects of interest for the simulation, said method comprising, for each image:
computing, by the graphics board, the colours of the pixels of the image in order to represent the standard objects, storing the colours of the pixels in order to represent the standard objects, in a buffer memory of the graphics board;
for each object of interest:
computing at least two projection matrices of the object of interest in an image plane by the application, the said matrices being offset spatially relative to one another;
for each previously-computed matrix, computing, by the graphics board, second coverage masks of the pixels of the image plane;
cumulating, by the application, the second coverage masks of the pixels of the image by the object of interest in the buffer memory of the graphics board;
computing, by the graphics board, colours of the image plane for the pixels representing the object of interest;
cumulating, by the application, the colours of the object of interest in the buffer memory of the graphics board; and
displaying the buffer memory by the graphics board.

2. The method according to claim 1, wherein a weighting is applied to each coverage mask computed for a projection matrix during the cumulating by the application of the second coverage masks.

3. The method according to claim 1, wherein the projection matrices are spatially offset between each image.

4. The method according to claim 1, wherein each projection matrix is centered on a sampling of a target object to be displayed by a pixel.
